(19) United States
(12) Patent Application Publication
(10) Pub. No.: US 2026/0094886 A1
(43) Pub. Date: Apr. 2, 2026

(54) APPARATUS AND METHOD FOR INSPECTING POUCH SEALING THICKNESS

(71) Applicant: SAMSUNG SDI CO., LTD., Yongin-si (KR)

(72) Inventor: Sac LEE, Yongin-si (KR)

(21) Appl. No.: 19/257,710

(22) Filed: Jul. 2, 2025

(30) Foreign Application Priority Data
Sep. 27, 2024 (KR) 10-2024-0131763

(51) Int. Cl. H01M 10/42; G01B 11/06; G01N 21/88; H01M 50/105; H01M 50/184

(52) U.S. Cl. CPC H01M 10/4285; G01B 11/06; G01N 21/8806; H01M 50/105; H01M 50/184

(57) ABSTRACT

An apparatus for inspecting a pouch sealing thickness, the apparatus including a first confocal sensor unit configured to measure a first thickness of one of a side sealing and a tab sealing of a pouch battery cell, a second confocal sensor unit configured to measure a second thickness of the side sealing and the tab sealing of the pouch battery cell, resulting in two measured thicknesses, a transport unit configured to transport the pouch battery cell to the first confocal sensor unit and the second confocal sensor unit, and a control unit configured to determine whether the pouch battery cell has a sealing defect from the two measured thicknesses.

### CROSS-REFERENCE TO RELATED APPLICATION

This application claims priority to and the benefit of Korean Patent Application No. 10-2024-0131763, filed on Sep. 27, 2024, the disclosure of which is incorporated herein by reference in its entirety.

### BACKGROUND

### 1. Field

Aspects of some embodiments of the present disclosure relate to an apparatus and a method for inspecting a pouch sealing thickness in a non-contact manner.

### 2. Description of the Related Art

Unlike primary batteries that cannot be charged, secondary batteries are batteries that can be charged and discharged. Low-capacity batteries are used in small, portable electronics such as smartphones, feature phones, notebook computers, digital cameras, and camcorders, while high-capacity batteries are widely used as power sources for motors in hybrid and electric vehicles and for power storage. A secondary battery may broadly include an electrode assembly consisting of a positive electrode plate, and a negative electrode plate, a case for accommodating the electrode assembly, and an external terminal connected to the electrode assembly.

In a pouch cell assembly process in the related art, a sealing process is a process of compressively sealing two pouches with heat. Since the sealing process is performed by compressing the pouch by a mold, the thickness of the sealed pouch is an important factor in checking sealing quality. In the related art, sampling inspection is performed using a manual or semi-automatic measuring device in order to measure the thickness of a pouch sealing. However, manual inspection devices have problems in that the accuracy of thickness measurement is reduced due to inaccuracy of measurement points between measurers and changes in the thickness of a measured product caused by contact measurement.

The above information disclosed in this Background section is for enhancement of understanding of the background of the present disclosure, and therefore, it may contain information that does not constitute prior art.

### SUMMARY

Embodiments include an apparatus for inspecting a pouch sealing thickness, the apparatus including a first confocal sensor unit configured to measure a first thickness of one of a side sealing and a tab sealing of a pouch battery cell, a second confocal sensor unit configured to measure a second thickness of the side sealing and the tab sealing of the pouch battery cell, resulting in two measured thicknesses, a transport unit configured to transport the pouch battery cell to the first confocal sensor unit and the second confocal sensor unit, and a control unit configured to determine whether the pouch battery cell has a sealing defect from the two measured thicknesses.

The apparatus for inspecting a pouch sealing thickness may further include a rotation unit configured to rotate the pouch battery cell 90° before the pouch battery cell enters the second confocal sensor unit, a sealing thickness of the pouch cell being measured by the first confocal sensor unit.

The rotation unit may be configured to rotate the pouch battery cell so that a sealing part of the pouch battery cell matches a scan line of the second confocal sensor unit.

The apparatus for inspecting a pouch sealing thickness may further include a position alignment unit configured to align a position of the pouch battery cell before the pouch battery cell enters the first confocal sensor unit.

The position alignment unit may be configured to align positions of a first side surface, a second side surface, and a third side surface of the pouch battery cell on a conveyor, place the pouch battery cell on a shuttle, and align a fourth side surface of the pouch battery cell on the conveyor, and wherein the transport unit is configured to transport the shuttle.

The first side surface may be a left side surface, the second side surface may be right side surface, the third side surface may be a rear side surface, and the fourth side surface may be a front side surface of the pouch battery cell.

The position alignment unit may include a reference stage protruding in a tab direction of the pouch battery cell, the reference stage being configured to align tab parts of the pouch battery cell, and a centering block that pushes the pouch battery cell toward the reference stage.

The control unit may be configured to control the first confocal sensor unit and the second confocal sensor unit to measure each of the two measured thicknesses of the pouch battery cell while moving the pouch battery cell a predetermined measurement interval by the transport unit.

The control unit may be configured to determine a type of defect from a profile of data about the two measured thicknesses.

When an average thickness of the pouch battery cell in an electrode area is outside a normal range or a deviation in a thickness in the electrode area is outside a predetermined range, the control unit may be configured to determine that the pouch battery cell has a defect.

Embodiments include a method for inspecting a pouch sealing thickness, the method including measuring a first thickness of one of a side sealing and a tab sealing of a pouch battery cell using a first confocal sensor unit, rotating the pouch battery cell 90°, and measuring a second thickness of the other of the side sealing and the tab sealing of the pouch battery cell using a second confocal sensor unit.

The rotating may include rotating the pouch battery cell so that a sealing part of the pouch battery cell matches a scan line of the second confocal sensor unit.

The method for inspecting a pouch sealing thickness may further include aligning a position of the pouch battery cell before measuring the first thickness.

The aligning may include aligning positions of a first side surface, a second side surface and third side surface of the pouch battery cell on a conveyor, placing the pouch battery cell on a shuttle, and aligning a fourth surface of the pouch battery cell.

The first side surface may be a left side surface, the second side surface may be right side surface, the third side surface may be a rear side surface, and the fourth side surface may be a front side surface of the pouch battery cell.

Aligning a position of the pouch cell before measuring the first thickness may include pushing the pouch battery cell using a centering block toward a reference stage that protrudes in a tab direction of the pouch battery cell, and aligning tab parts of the pouch battery cell.

In measuring the first thickness and the second thickness, a sealing thickness of the pouch battery cell is measured by the first confocal sensor unit and the second confocal sensor unit while moving the pouch battery cell by a predetermined measurement interval.

The method for inspecting a pouch sealing thickness may further include determining a defect type from a profile of data about the first thickness and the second thickness.

The determining may include determining that the pouch battery cell has a defect when an average thickness of the pouch battery cell in an electrode area is out of a normal range or a deviation in a thickness in the electrode area is out of a predetermined range.

### BRIEF DESCRIPTION OF THE DRAWINGS

Features will become apparent to those of ordinary skill in the art by describing in detail exemplary embodiments with reference to the attached drawings, in which:

FIG. 1 is a partial exploded perspective view of a pouch type battery according to one or more embodiments of the present disclosure;

FIG. 2 is a conceptual diagram for explaining a sealing process of a pouch type battery according to one or more embodiments of the present disclosure;

FIG. 3 is a diagram illustrating a tap sealing and a side sealing of a pouch type battery according to one or more embodiments of the present disclosure;

FIGS. 4A and 4B are explanatory diagrams for explaining the principle of inspecting a sealing thickness by using a confocal sensor according to one or more embodiments of the present disclosure;

FIG. 5 is a functional block diagram illustrating the configuration of an apparatus for inspecting a pouch sealing thickness according to one or more embodiments of the present disclosure;

FIG. 6 is a flowchart illustrating the procedure of a method for inspecting a pouch sealing thickness according to one or more embodiments of the present disclosure;

FIGS. 7A and 7B are explanatory diagrams for explaining a method of pouch position alignment according to one or more embodiments of the present disclosure;

FIG. 8 is a diagram illustrating an example of inspecting a sealing thickness while transporting a pouch cell along a transport path according to one or more embodiments of the present disclosure;

FIG. 9 is a diagram illustrating a process of rotating a shuttle 90° after a side sealing scan and performing a tap sealing scan according to one or more embodiments of the present disclosure; and

FIGS. 10A through 10D are diagrams illustrating several examples of a profile measured according to a type of defect according to embodiments of the present disclosure.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Terms or words used in this specification and claims should not be construed as being limited to common or dictionary meanings but instead should be understood to have meanings and concepts in agreement with the spirit of the present disclosure based on the principle that an inventor can define the concept of each term suitably in order to describe his/her own embodiments in the best way possible. Accordingly, since the embodiments described in this specification and the configurations illustrated in the drawings are only an example of the present disclosure and they do not cover all the technical ideas of the present disclosure, it should be understood that various changes and modifications may be made at the time of filing this application.

It will be further understood that the terms “comprises/includes” and/or “comprising/including” when used herein, specify the presence of stated features, integers, steps, operations, elements, components, and/or groups thereof, but do not preclude the presence or addition of one or more other features, integers, steps, operations, elements, components, and/or groups thereof.

In order to facilitate understanding of the present disclosure, the accompanying drawings are not drawn to scale and the dimensions of some components may be exaggerated. It should be noted that the same reference numerals are designated to the same components in different embodiments.

Reference to two compared elements, features, etc. as being “the same” means that they are “substantially the same”. Therefore, the phrase “substantially the same” may include a deviation that is considered low in the art, for example, a deviation of 5% or less. The uniformity of any parameter in a given region may mean that it is uniform from an average perspective.

Although the terms such as “first” and/or “second” are used to describe various components, these components are not limited by these terms, of course. These terms are only used to distinguish one component from another component. Thus, unless specifically stated to the contrary, a first component may be termed a second component without departing from the teachings of exemplary embodiments.

Throughout the specification, unless otherwise stated, each element may be singular or plural.

Arrangement of any component “above (or below)” or “on (or under)” a component may mean that any component is disposed in contact with the upper (or lower) surface of the component, as well as that other components may be interposed between the element and any element disposed on (or under) the element.

It will be understood that, when a component is referred to as being “connected”, “coupled”, or “joined” to another component, not only can it be directly “connected”, “coupled”, or “joined” to the other element, but also can it be indirectly “connected”, “coupled”, or “joined” to the other element with other elements interposed therebetween.

As used herein, the term “and/or” includes any and all combinations of one or more of the associate listed items. The use of “may” when describing embodiments of the present disclosure relates to “one or more embodiments of the present disclosure”. Expressions such as “at least one” and “one or more” preceding a list of elements modify the entire list of elements and do not modify the individual elements in the list.

Throughout the specification, when “A and/or B” is stated, it means A, B, or A and B, unless otherwise stated. In addition, when “C to D” is stated, it means C or more and D or less, unless specifically stated to the contrary.

When the phrase such as “at least one of A, B, and C”, “at least one of A, B, or C”, “at least one selected from the group of A, B, and C”, or “at least one selected from among A, B, and C” is used to designate a list of elements A, B, and C, the phrase may refer to any and all suitable combinations.

The term “use” may be considered synonymous with the term “utilize”. As used herein, the terms “substantially,” “about,” and similar terms are used as terms of approximation rather than as terms of degree, and are intended to account for inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Accordingly, a first element, component, region, layer, or section discussed below may be termed a second element, component, region, layer, or section without departing from the teachings of exemplary embodiments.

For ease of explanation in describing the relationship of one element or feature to another element(s) or feature(s) as illustrated in the drawings, spatially relative terms such as “beneath”, “below”, “lower”, “above”, and “upper” may be used herein. It will be understood that spatially relative positions are intended to encompass different directions of the device in use or operation in addition to the direction depicted in the drawings. For example, if the device in the drawings is turned over, any element described as being “below” or “beneath” another element would then be oriented “above” or “over” another element. Therefore, the term “below” may encompass both upward and downward directions.

The terminology used herein is for the purpose of describing embodiments of the present disclosure and is not intended to limit the present disclosure.

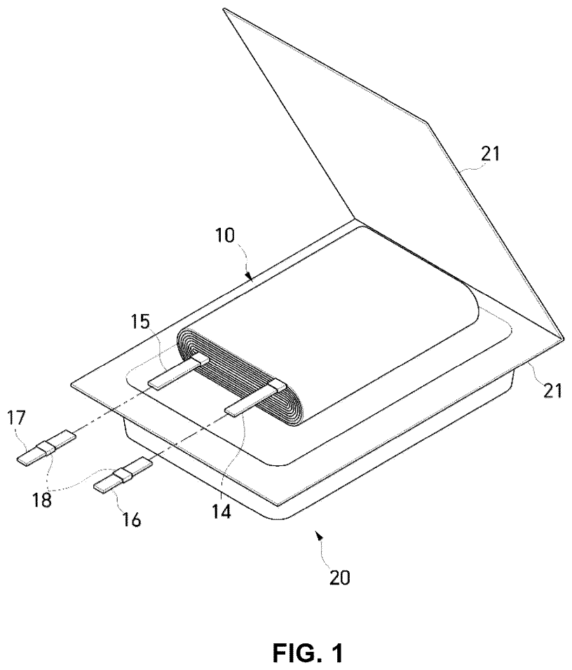

FIG. 1 is a partial exploded perspective view of a pouch type secondary battery.

The pouch type secondary battery includes an electrode assembly 10 and a pouch 20 accommodating the electrode assembly 10.

A first electrode tab 14 and a second electrode tab 15 as shown in FIG. 1 are respectively welded to a first electrode lead 16 and a second electrode lead 17 of an external terminal to be electrically connected to the outside. A tab film 18 for insulation from the pouch 20 may be attached to the first electrode lead 16 and the second electrode lead 17.

In a state in which the electrode assembly 10 is accommodated in the pouch 20, sealing parts 21 of edges of the pouch 20 come into contact with each other to be sealed. The sealing is performed in a state in which the tab film 18 is disposed between the sealing parts 21. The sealing parts 21 at the bottom portion of the pouch 20 as well as the top portion may be made of a heat-fusible material and may have a structure in which sealing may be achieved by bonding heat-fusible layers to each other. Because the heat-fusible material generally has weak adhesion to metal, the tab film 18 may be in the form of a thin film attached to a tab to be fused to the pouch 20.

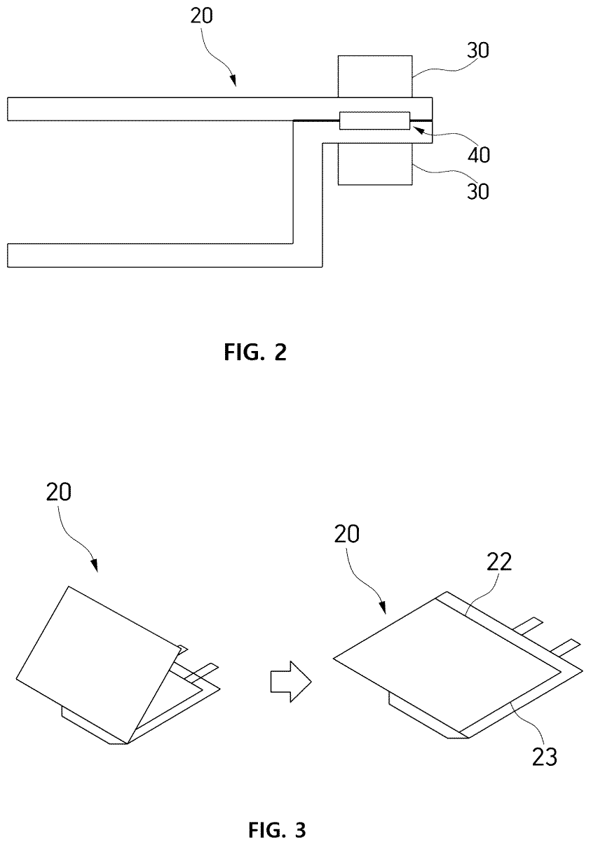

FIG. 2 is a conceptual diagram for explaining a sealing process of a pouch type battery (e.g., that shown in FIG. 1), and FIG. 3 is a diagram illustrating a tap sealing and a side sealing of a pouch type battery. In a pouch cell (e.g., a pouch battery cell) assembly process, a sealing process may be a process of compressively sealing two pouches (e.g., two pouch sealing parts) with heat. That is, in a tab sealing part 22 and a side sealing part 23 of a pouch 20 illustrated in FIG. 3, a thermally fused part 40 interposed between the two pouches may be thermally compressed by a mold 30 as illustrated in FIG. 2. The thickness of the pouch sealed in this way is one factor in checking sealing quality.

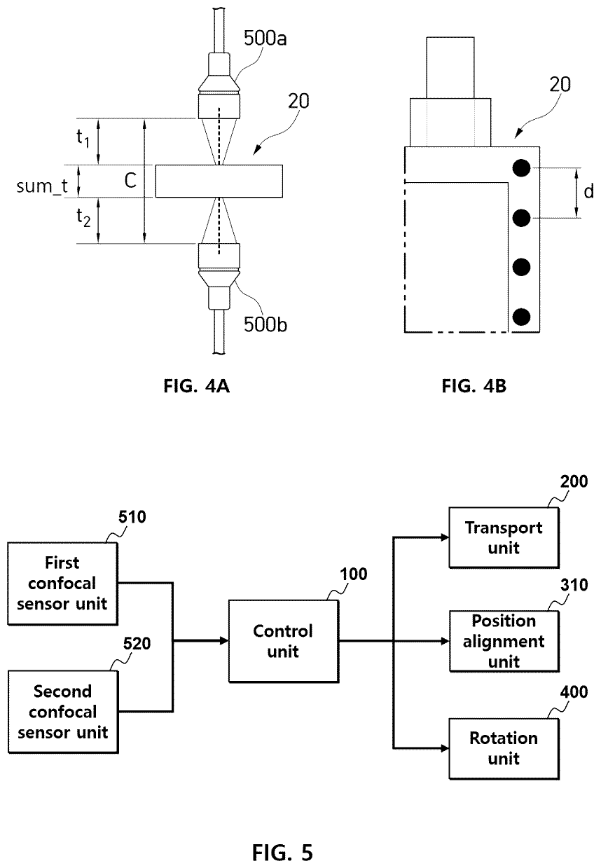

FIGS. 4A and 4B are explanatory diagrams for explaining the principle of inspecting a sealing thickness using a confocal sensor. One confocal sensor unit includes two confocal sensors 500a and 500b. In order to measure a sealing thickness, distances to the pouch sealing parts are measured by the two confocal sensors 500a and 500b, respectively as illustrated in FIG. 4A. The distances are set as t₁ and t₂, respectively, and when a distance between the confocal sensors 500a and 500b is C, the sealing thickness sum_t may be obtained by the following equation:

$$sum\_t = C - ( {t}_{1} + {t}_{2} ) .$$

The sealing thickness may be measured at regular intervals along the sealing part as illustrated in FIG. 4B. The closer the measurement interval d is, the more precise the measurement is. For example, if the measurement interval d=20 μm, the scan speed=200 mm/s, and the sampling rate=10 kHz may be set to measure the sealing thickness.

FIG. 5 is a functional block diagram illustrating the configuration of an apparatus for inspecting a pouch sealing thickness according to one or more embodiments of the present disclosure.

The apparatus for inspecting a pouch sealing thickness of the present disclosure includes a first confocal sensor unit 510 for measuring the thickness of a side sealing and a second confocal sensor unit 520 for measuring the thickness of a tab sealing. A pouch cell passes through the first confocal sensor unit 510 and the second confocal sensor unit 520 while being transported by a transport unit 200. A position alignment unit 310 aligns the position of the pouch cell before the pouch cell enters the first confocal sensor unit 510. A rotation unit 400 rotates the pouch cell 90° so that a tab sealing part of the pouch cell matches a scan line of the second confocal sensor unit 520 before the pouch cell enters the second confocal sensor unit 520, a side sealing thickness of the pouch cell being measured by the first confocal sensor unit 510. For example, a servo motor may be used as the rotation unit 400. Depending on an embodiment, it is also possible to measure the tab sealing thickness by using the first confocal sensor unit 510 and measure the side sealing thickness by using the second confocal sensor unit 520 by rotating the pouch cell by 90°.

The control unit 100 controls (e.g., is configured to control) the transport unit 200, the position alignment unit 310, and the rotation unit 400 to measure the pouch sealing thickness while allowing the pouch cell to pass through the first confocal sensor unit 510 and the second confocal sensor unit 520, and determines (e.g., is configured to determine) whether the pouch cell has a sealing defect from data about the sealing thicknesses measured by the first confocal sensor unit 510 and the second confocal sensor unit 520. For example, when the measured sealing thickness is equal to or greater than a predetermined threshold value, the control unit 100 may determine that the pouch cell has a defect. In an embodiment, when a deviation in the measured sealing thickness (e.g., either measured sealing thickness) is equal to or greater than a predetermined threshold value, the control unit 100 may determine that the pouch cell has a defect. In an embodiment, the control unit 100 may determine the type of defect from a profile of the data about the sealing thicknesses.

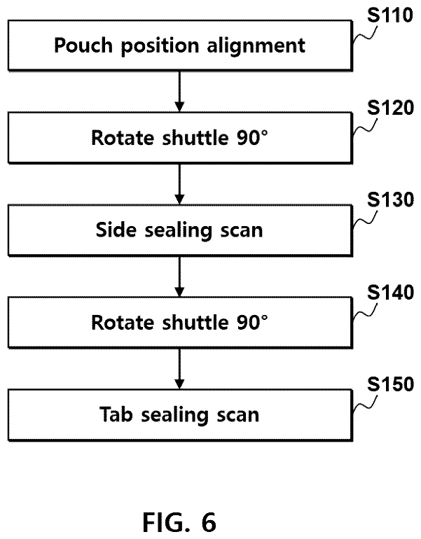

FIG. 6 is a flowchart illustrating a method for inspecting a pouch sealing thickness according to an embodiment of the present disclosure.

First, the position alignment unit 310 aligns the position of the pouch cell before the pouch cell enters the first confocal sensor unit 510 (step S110). In this step, the pouch cell placed on a shuttle may be held by lower vacuum after the pouch cell is located at a correct position through centering.

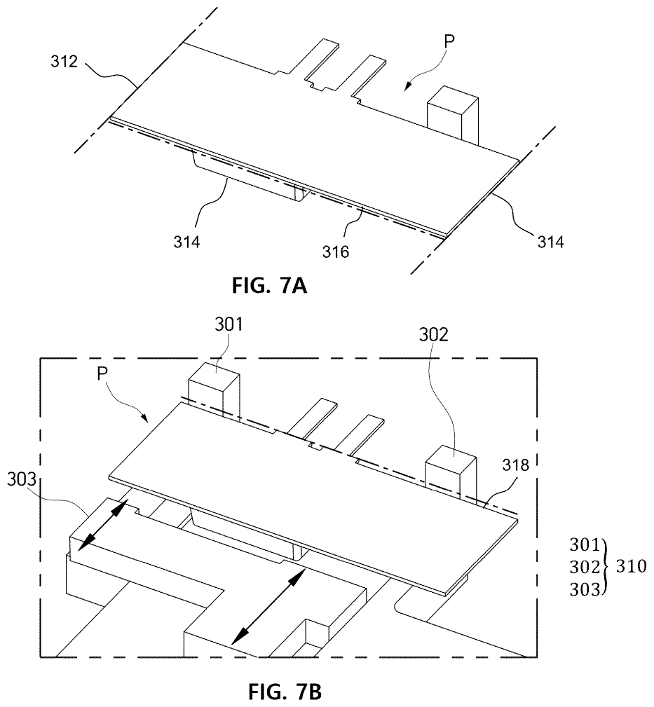

FIGS. 7A and 7B illustrate an example of a position alignment method of a pouch cell P. As illustrated in FIG. 7A, the position alignment unit 310 aligns three surfaces (e.g., side surfaces) of left 312, right 314, and rear 316 surfaces of the pouch cell P on a conveyor, and then places the pouch cell P on the shuttle and aligns the remaining surface 318 (e.g., a front side surface) as illustrated in FIG. 7B. As illustrated in FIG. 7B, the position alignment unit 310 includes a plurality of reference stages 301 and 302 for aligning tab parts of the pouch cell in the tab direction of the pouch cell. The position alignment unit 310 may align the pouch cell P by pushing the pouch cell P toward the reference stages 301 and 302 with a centering block 303 so that the pouch cell reaches the reference stages 301 and 302 that protrude. This alignment may reduce a profile dispersion during a tab sealing scan operation and reduce the setting loss of an operator. In addition, depending on an embodiment, cell transportation and 90° rotation operations may be configured to be performed using only a lower vacuum grip 320 without using a pusher above the pouch cell. With this configuration, since no upper pusher is used, an upper pusher operation is omitted, so that a facility operation is simplified.

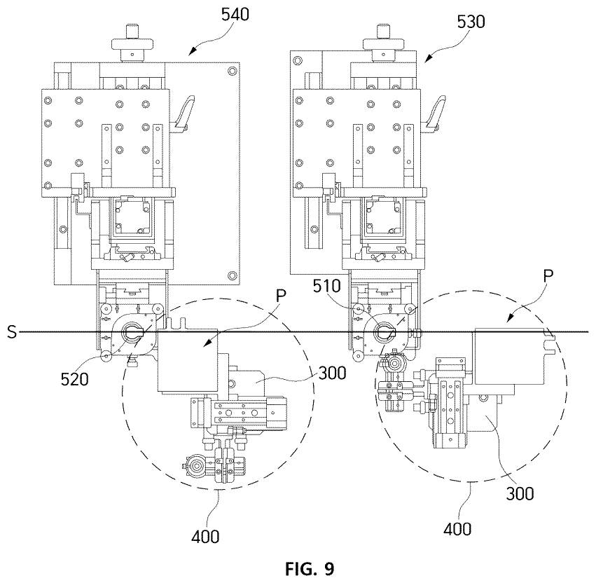

When the alignment of the pouch cell is completed, the rotation unit 400 (see FIG. 9) rotates the shuttle 90° (step S120). By the operation of step S120, the side sealing part of the pouch cell P matches a scan line S of the first confocal sensor unit 510 as illustrated on the right side of FIG. 9. When the side sealing part of the pouch cell P matches the scan line S of the first confocal sensor unit 510 by the alignment operation of step S110, step S120 may be omitted.

Subsequently, the control unit 100 controls the first confocal sensor unit 510 to measure the side sealing thickness of the pouch cell P while moving the pouch cell P by the transport unit 200 by a measurement interval d illustrated in FIG. 4B (step S130).

When the measurement of the side sealing thickness is completed, the rotation unit 400 rotates the shuttle 90° (step S140). By the operation of step S140, the tab sealing part of the pouch cell P matches the scan line S of the second confocal sensor unit 520 as illustrated on the left side of FIG. 9. In the example of FIG. 9, the pouch cell P may be rotated 90° in a counterclockwise direction so that the tab sealing part matches a scan line S of the second confocal sensor unit 520. FIG. 9 illustrates a case in which the scan line S of the first confocal sensor unit 510 and the scan line S of the second confocal sensor unit 520 are connected to each other as one straight line; however, the scan lines may not coincide.

Subsequently, the control unit 100 controls the second confocal sensor unit 520 to measure the tab sealing thickness of the pouch cell P while moving the pouch cell P by the transport unit 200 by the measurement interval d illustrated in FIG. 4B (step S150).

FIGS. 6 and 9 have described the case of measuring the tab sealing thickness after measuring the side sealing thickness; however, it can also be configured such that the tab sealing thickness is first measured, the pouch cell is rotated, and then the side sealing thickness is measured. For example, it can be configured such that the tab sealing thickness is measured by the first confocal sensor unit, the pouch cell is rotated 90° in a clockwise direction, and then the side sealing thickness is measured by the second confocal sensor unit.

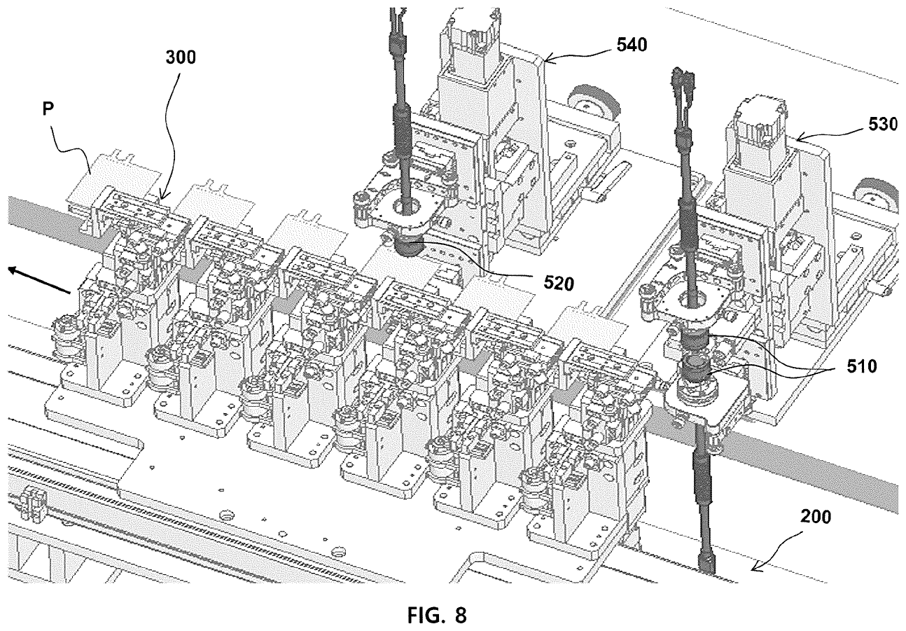

FIG. 8 is a diagram illustrating an example of inspecting a sealing thickness while transporting pouch cells P along a transport path in the direction of an arrow according to an embodiment of the present disclosure. In the example of FIG. 8, the sealing thickness is measured while transporting six pouch cells P by the transport unit 200. The pouch cells P are placed on a shuttle 300, and the transport unit 200 transports the shuttle 300. As the pouch cells P are transported, sealing parts of the pouch cells pass through between two confocal sensors of the first confocal sensor unit 510 and between two confocal sensors of the second confocal sensor unit 520. The first confocal sensor unit 510 and the second confocal sensor unit 520 are supported by supports 530 and 540, respectively.

As shown in FIG. 9, the pouch cells P are individually rotated 90° between the first confocal sensor unit 510 and the second confocal sensor unit 520. That is, when two of the six pouch cells P have passed through the first confocal sensor unit 510 and four pouch cells P have not passed through the first confocal sensor unit 510, tab sealing parts of the two pouch cells P having passed through the first confocal sensor unit 510 have been rotated 90° toward the second confocal sensor unit 520 and side sealing parts of the remaining four pouch cells P have been directed toward the first confocal sensor unit 520.

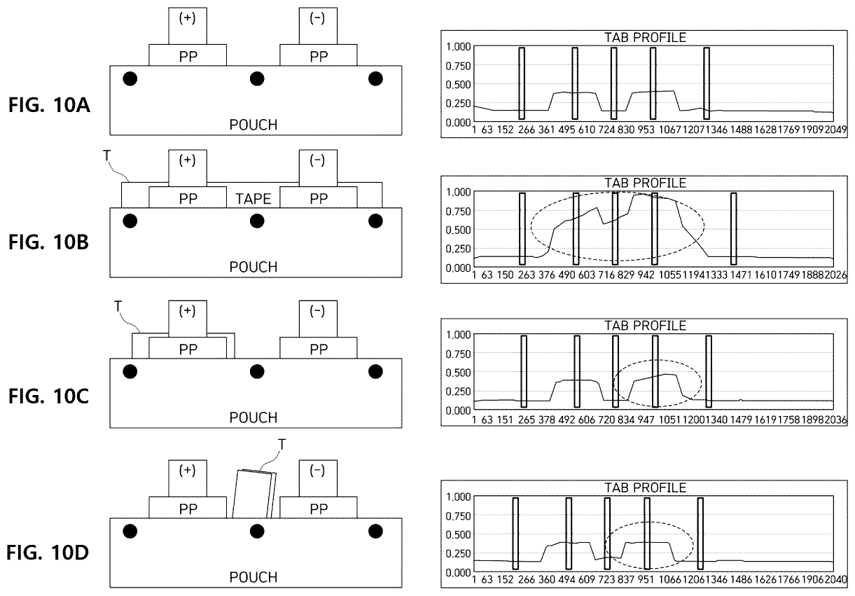

In an embodiment, the control unit 100 (see FIG. 5) may determine the type of defect from the profile of data about the measured sealing thicknesses. FIGS. 10A to 10D are diagrams illustrating several examples of a profile (hereinafter, referred to as a “tap profile”) of data about a measured tab sealing thickness according to the type of defect. FIG. 10A illustrates a pouch cell of a good product and a tab profile measured at this time. As can be seen from the tab profile of FIG. 10A, the thickness may be thick (e.g., relatively thick) in an electrode area and thin in the remaining areas. It can also be seen that the thickness in the electrode area is uniform to a certain degree. When the measured tab profile does not show such characteristics, the control unit 100 may determine that a corresponding pouch cell has a defect. That is, when an average thickness of the pouch cell in an electrode area is out of a normal range or a deviation in a thickness in the electrode area is out of a predetermined range, the control unit may determine that the pouch cell has a defect.

FIG. 10B illustrates a defective pouch cell in which a tape T protrudes in a tab direction as a whole and a tab profile measured at this time. When the profiles of FIGS. 10A and 10B are compared with each other, it can be seen that in the case of FIG. 10B, the thickness is thick overall, the thickness in the electrode area is not uniform, and the thickness between electrodes is also thick.

FIG. 10C illustrates a defective pouch cell in which the tape T protrudes from a positive electrode area and a tab profile is measured at that time. When the tab profiles of FIGS. 10A and 10C are compared with each other, it can be seen that in the case of FIG. 10C, the thickness of an electrode in which the tape protrudes is thick on average and the thickness in the electrode area is not uniform.

FIG. 10D illustrates a defective pouch cell in which the tape T protrudes between electrodes and a tab profile is measured at that time. When the tab profiles of FIGS. 10A and 10D are compared with each other, it can be seen that in the case of FIG. 10D, the thickness in an area between the electrodes is thick on average and is not uniform.

An object of the present disclosure is to propose an apparatus and a method for inspecting a pouch sealing thickness that can inspect the thickness of a pouch sealing in a non-contact manner.

Another object of the present disclosure is to propose an apparatus and a method for inspecting a pouch sealing thickness that can efficiently inspect an entire pouch sealing thickness.

The present disclosure can inspect the thickness of a pouch sealing in a non-contact manner.

In addition, the present disclosure can efficiently inspect an entire pouch sealing thickness and thus stabilize the quality of a pouch cell.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of ordinary skill in the art that various changes in form and details may be made without departing from the spirit and scope of the present invention as set forth in the following claims.

What is claimed is:

1. An apparatus for inspecting a pouch sealing thickness, the apparatus comprising:
a first confocal sensor unit configured to measure a first thickness of one of a side sealing and a tab sealing of a pouch battery cell;
a second confocal sensor unit configured to measure a second thickness of the side sealing and the tab sealing of the pouch battery cell, resulting in two measured thicknesses;
a transport unit configured to transport the pouch battery cell to the first confocal sensor unit and the second confocal sensor unit; and
a control unit configured to determine whether the pouch battery cell has a sealing defect from the two measured thicknesses.

2. The apparatus for inspecting a pouch sealing thickness as claimed in claim 1, the apparatus further comprising a rotation unit configured to rotate the pouch battery cell 90° before the pouch battery cell enters the second confocal sensor unit, a sealing thickness of the pouch cell being measured by the first confocal sensor unit.

3. The apparatus for inspecting a pouch sealing thickness as claimed in claim 2, wherein the rotation unit is configured to rotate the pouch battery cell so that a sealing part of the pouch battery cell matches a scan line of the second confocal sensor unit.

4. The apparatus for inspecting a pouch sealing thickness as claimed in claim 1, the apparatus further comprising a position alignment unit configured to align a position of the pouch battery cell before the pouch battery cell enters the first confocal sensor unit.

5. The apparatus for inspecting a pouch sealing thickness as claimed in claim 4, wherein the position alignment unit is configured to:
align positions of a first side surface, a second side surface, and a third side surface of the pouch battery cell on a conveyor,
place the pouch battery cell on a shuttle, and
align a fourth surface of the pouch battery cell on the conveyor, and wherein the transport unit is configured to transport the shuttle.

6. The apparatus for inspecting a pouch sealing thickness as claimed in claim 5, wherein the first side surface is a left side surface, the second side surface is right side surface, the third side surface is a rear side surface, and the fourth side surface is a front side surface of the pouch battery cell.

7. The apparatus for inspecting a pouch sealing thickness as claimed in claim 4, wherein the position alignment unit comprises:
a reference stage protruding in a tab direction of the pouch battery cell, the reference stage being configured to align tab parts of the pouch battery cell; and
a centering block that pushes the pouch battery cell toward the reference stage.

8. The apparatus for inspecting a pouch sealing thickness as claimed in claim 1, wherein the control unit is configured to control the first confocal sensor unit and the second confocal sensor unit to measure each of the two measured thicknesses of the pouch battery cell while moving the pouch battery cell a predetermined measurement interval by the transport unit.

9. The apparatus for inspecting a pouch sealing thickness as claimed in claim 8, wherein the control unit is configured to determine a type of defect from a profile of data about the two measured thicknesses.

10. The apparatus for inspecting a pouch sealing thickness as claimed in claim 9, wherein when an average thickness of the pouch battery cell in an electrode area is outside a normal range or a deviation in a thickness in the electrode area is outside a predetermined range, the control unit is configured to determine that the pouch battery cell has a defect.

11. A method for inspecting a pouch sealing thickness, the method comprising:
measuring a first thickness of one of a side sealing and a tab sealing of a pouch battery cell using a first confocal sensor unit;
rotating the pouch battery cell 90°; and
measuring a second thickness of the other of the side sealing and the tab sealing of the pouch battery cell using a second confocal sensor unit.

12. The method for inspecting a pouch sealing thickness as claimed in claim 11, wherein the rotating includes rotating the pouch battery cell so that a sealing part of the pouch battery cell matches a scan line of the second confocal sensor unit.

13. The method for inspecting a pouch sealing thickness as claimed in claim 11, the method further comprising aligning a position of the pouch battery cell before measuring the first thickness.

14. The method for inspecting a pouch sealing thickness as claimed in claim 13, wherein the aligning comprises:
aligning positions of a first side surface, a second side surface and third side surface of the pouch battery cell on a conveyor;
placing the pouch battery cell on a shuttle; and
aligning a fourth side surface of the pouch battery cell.

15. The method for inspecting a pouch sealing thickness as claimed in claim 14, wherein the first side surface is a left side surface, the second side surface is right side surface, the third side surface is a rear side surface, and the fourth side surface is a front side surface of the pouch battery cell.

16. The method for inspecting a pouch sealing thickness as claimed in claim 13, wherein aligning a position of the pouch cell before measuring the first thickness includes:
pushing the pouch battery cell using a centering block toward a reference stage that protrudes in a tab direction of the pouch battery cell, and
aligning tab parts of the pouch battery cell.

17. The method for inspecting a pouch sealing thickness as claimed in claim 11, wherein in measuring the first thickness and the second thickness, a sealing thickness of the pouch battery cell is measured by the first confocal sensor unit and the second confocal sensor unit while moving the pouch battery cell by a predetermined measurement interval.

18. The method for inspecting a pouch sealing thickness as claimed in claim 17, the method further comprising determining a defect type from a profile of data about the first thickness and the second thickness.

19. The method for inspecting a pouch sealing thickness as claimed in claim 18, wherein the determining includes determining that the pouch battery cell has a defect when an average thickness of the pouch battery cell in an electrode area is out of a normal range or a deviation in a thickness in the electrode area is out of a predetermined range.
